(19) United States
(12) Patent Application Publication
(10) Pub. No.: US 2005/0044505 A1
(43) Pub. Date: Feb. 24, 2005

(54) Creating an opaque graphical user interface window when a display unit is in an off state

(76) Inventors: Clifton W. Laney, Beaverton, OR (US); Robert A. Dunstan, Forest Grove, OR (US); Dan Nowlin, Hillsboro, OR (US)

Correspondence Address: Buckley, Maschoff, Talwalkar & Allison LLC, Five Elm Street, New Canaan, CT, 06840, US

(21) Appl. No.: 10/643,421

(22) Filed: Aug. 19, 2003

(51) Int. Cl. G09G 5/00

(52) U.S. Cl. 715/781; 715/790; 715/793; 715/794; 715/797; 715/802; 715/768

(57) ABSTRACT

According to some embodiments, an opaque graphical user interface window is created when a display unit is in an off state.

### BACKGROUND

A system, such as a Personal Computer (PC), may enter a low-power state. For example, a PC might enter a low-power state during a period of relative inactivity and/or when a user turns off a display device. As a result, energy can be conserved, the PC may operate more quietly (e.g., because a fan might not need to cool a processor), and/or battery life may be extended.

### BRIEF DESCRIPTION OF THE DRAWINGS

FIG. 1 illustrates graphical user interface windows.

FIG. 2 illustrates a transparent window according to some embodiments.

FIG. 3 illustrates an opaque window according to some embodiments.

FIG. 4 is a flow chart of a method that may be performed when a display unit is turned off according to some embodiments.

FIG. 5 is a flow chart of a method that may be performed when a display unit is turned on according to some embodiments.

FIG. 6 is a flow chart of a method according to some embodiments.

FIG. 7 illustrates a computer system according to some embodiments.

### DETAILED DESCRIPTION

Some embodiments described here are directed to a “system.” As used herein, the term “system” may refer to any apparatus that includes one or more processors. Examples of a system include a desktop PC, a mobile system, a workstation, a server, a set top box (e.g., associated with a digital television receiver), and a game system. Some embodiments are also associated with a “low-power state,” which may refer to any state in which a system consumes less power as compared to a higher-power state. For example, the system may enter a low-power state when a user turns off a display device (and return to a higher-power state when the user turns on the display device).

Moreover, some embodiments are associated with Graphical User Interface (GUI) windows. A window is an area on a display, such as an area in which a user can interface with an application program (e.g., a word processing program). The windows may be associated with an Operating System (OS), such as the WINDOWS XP® OS available from MICROSOFT CORPORATION® or the JAGUAR® OS available from APPLE COMPUTERS®.

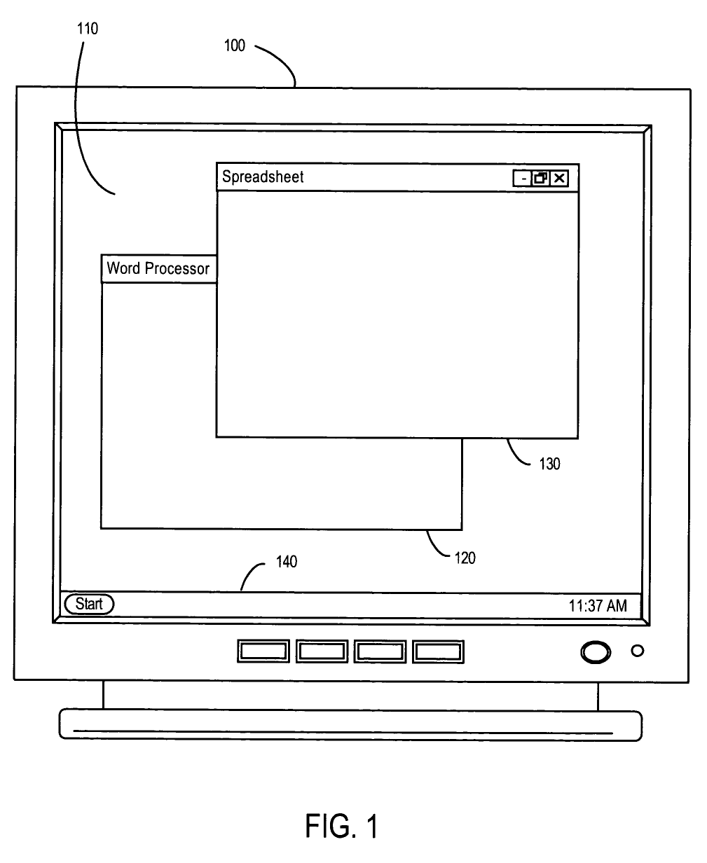

FIG. 1 illustrates a display unit 100 having a GUI display area 110. The display unit 100 might be, for example, a computer monitor or a Liquid Crystal Display (LCD) device.

The display area 110 includes a word processor window 120 and a spreadsheet window 130. Still another area or window 140 at the bottom of the display area 110 might include a “Start” icon and/or a time display. Note that windows may exist on different layers, referred to as the “Z order” (with Z representing the axis out of the plane of FIG. 1). For example, in FIG. 1 the word processor window 120 is “below” the spreadsheet window 130 in the Z order. As a result, the portion of the word processor window 120 that is under the spreadsheet window 130 is not visible (e.g., it is “covered up” by the spreadsheet window 130).

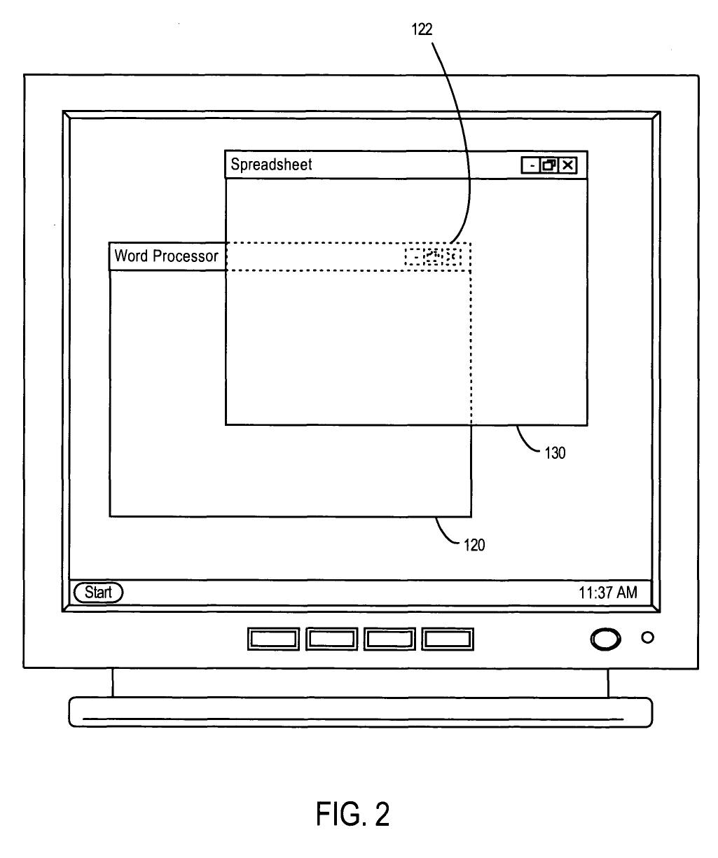

In some cases, a GUI window may be “transparent” (e.g., semi-transparent). That is, the system may use complex graphics processing (e.g., associated with a software compositing process and/or an alpha blending transform) to let a faint image of an underlying window be visible to a user through another window that is higher in the Z order. Consider, for example, FIG. 2 which illustrates a transparent spreadsheet window 130 according to some embodiments. In this case, a portion 122 of the word processor window 120 is faintly visible through the transparent spreadsheet window 130 (as represented by dotted lines in FIG. 2). Note that some windows may be transparent while other windows are “opaque” (e.g., substantially non-transparent). Moreover, texture might be applied to one or more windows, such as a “wave” texture that makes a window appear to undulate. Any number of such effects might be combined to modify windows before being rendered on the display. Note that these types of operations may require a significant amount of computational activity (and therefore consume a lot of power and generate a lot of heat).

Now consider what might happen if a user places a computer system in a low-power state in which the display unit is turned off but the system's processor still executes instructions (e.g., to digitally record a television show or to provide a stream of audio information to remote stereo device). Note that operations to generate and display a window might be performed by a main Central Processing Unit (CPU) and/or a specialized graphics engine. Moreover, applications that continue to execute when the display unit is turned off may still be associated with a window (and the operations to generate and display the window might still be performed when the display unit is turned off). For example, a user might press a button on a display monitor or on a PC case (or close the lid of a laptop computer) to place the system in a “visual off” state. In this case, the computer system might still be performing the complex graphics processing to support the transparent window 130—even though the display monitor has been turned off (and the user cannot see the result of that processing). In addition to graphics processing, supporting the transparent window 130 might place a significant load on a memory subsystem. Note that automatically closing and/or minimizing the application windows 120, 130 could degrade the performance of the applications and/or computer system.

Moreover, the processing required to support the transparent window could cause a graphics processor to generate a significant amount of heat—and a cooling fan may need to remain on to cool the graphics processor. As a result, the user will find that the computer system does not “sound like” it has been turned off even when he or she places the system into the “visual off” state.

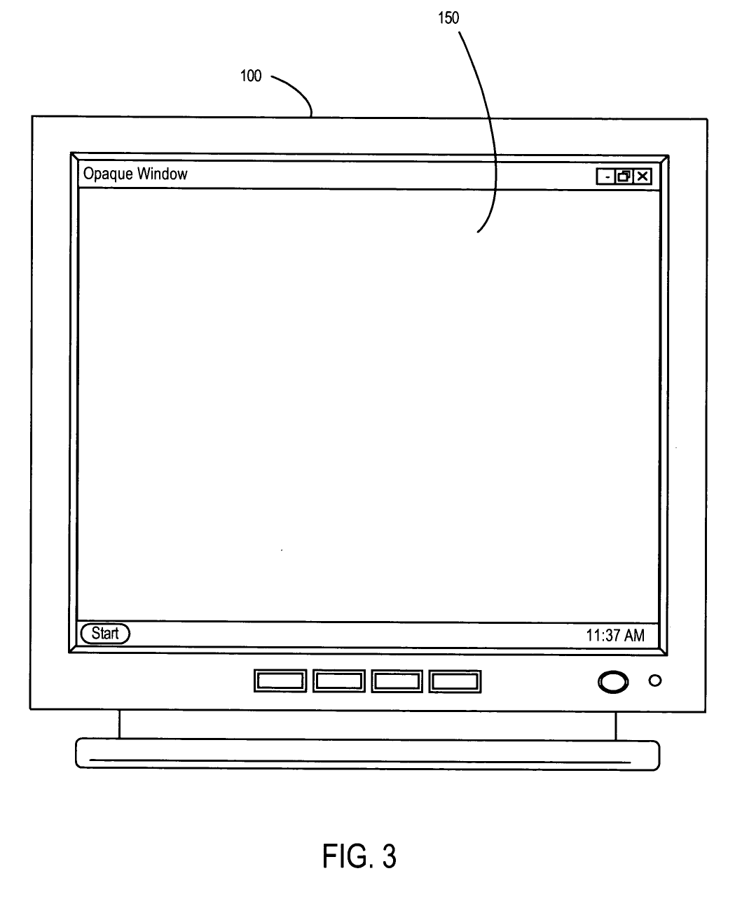

To reduce this problem, an opaque window may be created when a display unit is to be in an “off” state according to some embodiments. For example, FIG. 3 illustrates a display unit 100 and an opaque window 150 according to some embodiments. That is, the word processor window 120 and spreadsheet window 130 of FIG. 2 may still exist, but the presence of the opaque window 150 above them in the Z order means that the other windows 120, 130 cannot be seen. Moreover, the processing required to support the compositing of those other windows 120, 130 will not be performed (and, as a result, a cooling fan associated with a graphics processor might be turned off or spin more slowly).

Note that the opaque window 150 might occupy a substantial portion of the display area (e.g., as in FIG. 3 where the start button and time display are still visible) or might occupy the whole display area (e.g., so that nothing at all is visible). According to some embodiments, the opaque window 150 is simply a static black rectangle that occupies the entire display area.

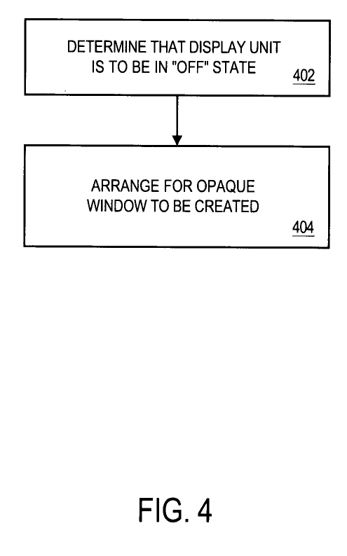

FIG. 4 is a flow chart of a method that may be performed when a display unit is turned off (e.g., immediately before or after the display unit turns off) according to some embodiments. The flow charts described herein do not necessarily imply a fixed order to the actions, and embodiments may be performed in any order that is practicable. Note that any of the methods described herein may be performed by hardware, software (including microcode), or a combination of hardware and software. For example, a storage medium may store thereon instructions that when executed by a machine results in performance according to any of the embodiments described herein.

At 402, it is determined that a display unit is to be in an “off” state. For example, an OS, a driver, or a Basic Input/Output System (BIOS) might receive from a user a request to turn off the display unit. Such a request might, for example, be associated with a low-power state in which the display unit is off, the keyboard and mouse do not operate, Light Emitting Diodes (LEDs) are disabled (e.g., on the PC and a hard disk drive), and the computer system's speakers are silent.

Note that the processor may still be executing instructions in the low-power state (e.g., to perform a virus scan). Also note that the display unit may be placed in the off state for reasons other than a user's affirmative request. For example, the system might automatically place the display unit in the off state during periods of relative inactivity (e.g., when there is no keyboard or mouse activity for a ten minute period in accordance with a power management policy). In addition, note that some portion of the display unit (or even the entire display unit) could still be “powered on” when the display unit is in an “off” state (e.g., the off state may be any state during which the display area is blanked).

At 404, it is arranged for an opaque GUI window to be created in response to the determination. Note that this might be performed before (or after) the display unit is actually placed in the off state.

The opaque window may be, for example, a static window that is placed at the top of the Z order (e.g., on top of any other existing windows) and that occupies substantially all of the GUI display area. The window might be established, for example, by a software application, a hardware device, an OS, a driver, and/or a BIOS. Note that the method may be performed, according to some embodiments, without making any changes to a traditional OS or application (e.g., the entire method might be performed by a driver or software filter).

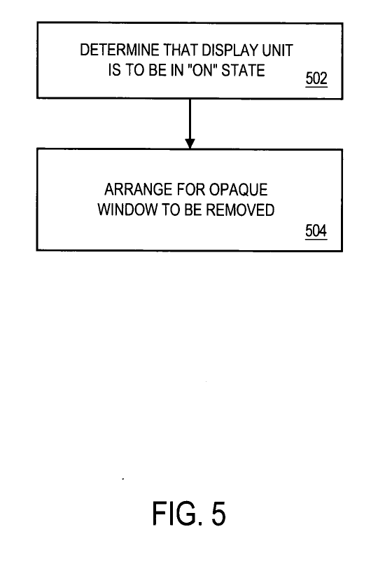

FIG. 5 is a flow chart of a method that may be performed when a display unit is turned on according to some embodiments. At 502, it is determined that a display unit is to be in an “on” state. For example, an OS, a driver, or a BIOS might receive from a user a request to turn on the display unit. At 504, it is arranged for the opaque GUI window to be removed in response to the determination. For example, the window may be “closed” and removed from the Z order.

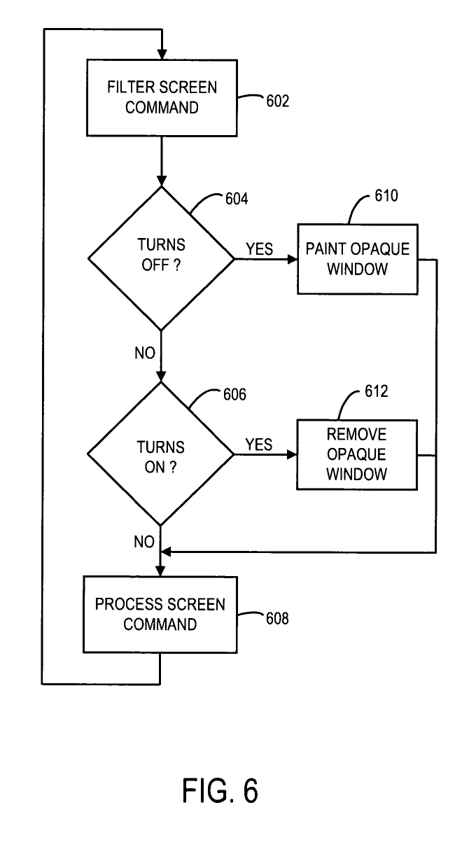

FIG. 6 is a flow chart of a method according to some embodiments. At 602, a screen command is checked by a software filter (e.g., a software filter that checks each and every screen command). If the screen command turns off the display unit at 604, an opaque window is painted at 610. If the screen command turns on the display unit at 606, the opaque window is removed at 612. The method continues at 608 where the “on” or “off” screen command may be processed. When the next screen command is received, the process may repeat from 602.

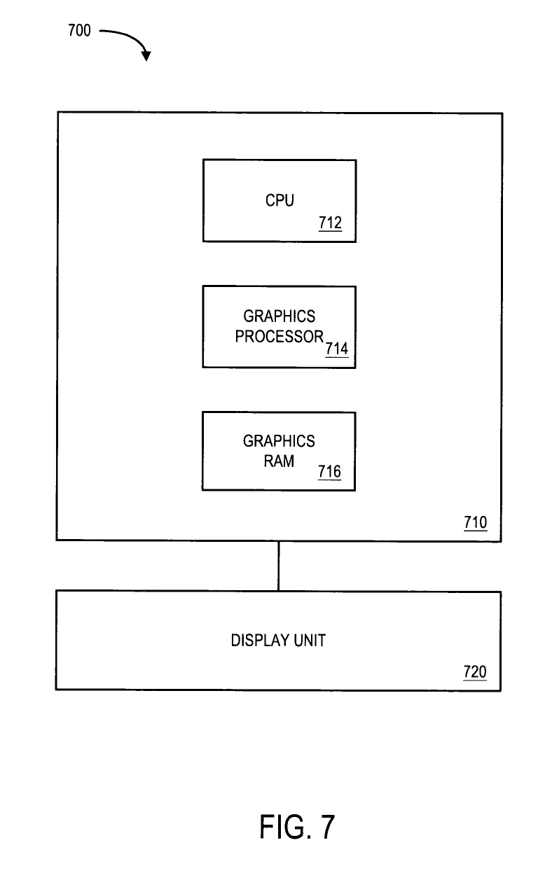

FIG. 7 illustrates a computer system 700 according to some embodiments. In particular, a processor unit 710 (e.g., a PC) provides information to a display unit 720 (e.g., a display monitor). According to some embodiments, a user can provide an affirmative indication that he or she is longer using the system 700. For example, the user might press a button (e.g., located on the processing system 710, a user input device such as a keyboard, a remote control, or the display unit 720) or select an icon to turn off the display unit 720. Note that it might not be appropriate to have the system 700 enter a low-power state immediately after receiving such an indication from a user (e.g., the processor unit 710 might need to continue executing instructions to support one or more remote devices). According to another embodiment, the low-power state is automatically entered after a period of relative inactivity.

The processor unit 710 may include a CPU 712 executing an OS and/or applications, a graphics processor 714, and/or graphics memory, such as graphics Random Access Memory (RAM) 716. To reduce the processing required to support a GUI display area when the display unit 720 is in an off state, any of the elements described herein may arrange for an opaque GUI window to be created.

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

According to some embodiments described herein, an entirely new window is created when the display unit is in the off state (e.g., is blanked). According to other embodiments, one or more existing translucent windows are made opaque when the display unit is off (and transparency is restored when the display unit is turned back on). Moreover, although some embodiments have been described with respect to a single display unit, embodiments may also be associated with multiple display units (e.g., multiple monitors). For example, an opaque window might be created for each display unit when that display unit is to be in an off state.

The several embodiments described herein are solely for the purpose of illustration. Persons skilled in the art will recognize from this description other embodiments may be practiced with modifications and alterations limited only by the claims.

1. A method, comprising:
determining that a display unit is to be in an off state; and
arranging for an opaque graphical user interface window to be created in response to the determination.

2. The method of claim 1, wherein the opaque window occupies substantially all of a graphical user interface area.

3. The method of claim 1, wherein a plurality of windows may co-exist in the graphical user interface and the opaque window is created such that it would be displayed on top of other windows.

4. The method of claim 1, wherein the off state is associated with a system's low-power state.

5. The method of claim 1, wherein said determining comprises:
receiving from a user a request to turn off the display unit.

6. The method of claim 1, wherein said determining is based on a period of relative inactivity.

7. The method of claim 1, further comprising:
determining that the display unit is to be in an on state; and
arranging for the opaque window to be removed.

8. The method of claim 1, wherein the display unit is associated with at least one of: (i) a desktop personal computer; (ii) a mobile system, (iii) a workstation, (iv) a server, (v) a set top box, and (vi) a game system.

9. The method of claim 1, wherein at least one of said determining and said arranging is associated with at least one of: (i) a software application, (ii) a hardware device, (iii) an operating system, (iv) a driver, and (v) a basic input/output system.

10. An apparatus, comprising:
an input to receive an indication that a display unit is to be in an off state; and
a device to arrange for an opaque graphical user interface window to be created in response to the indication.

11. The apparatus of claim 10, wherein the opaque window occupies substantially all of a graphical user interface area.

12. The apparatus of claim 10, wherein a plurality of windows may co-exist in the graphical user interface and the opaque window is created such that it would be displayed on top of other windows.

13. The apparatus of claim 10, wherein the off state is associated with a system's low-power state.

14. The apparatus of claim 10, further comprising:
wherein the device is to further arrange for the opaque window to be removed when the display unit is to be in an on state.

15. The apparatus of claim 10, wherein the device is associated with at least one of: (i) a desktop personal computer; (ii) a mobile system, (iii) a workstation, (iv) a server, (v) a set top box, and (vi) a game system.

16. An apparatus, comprising:
a storage medium having stored thereon instructions that when executed by a machine result in the following:
determining that a display unit is to be in an off state, and
arranging for an opaque graphical user interface window to be created in response to the determination.

17. The apparatus of claim 16, wherein the opaque window occupies substantially all of a graphical user interface area.

18. The apparatus of claim 16, wherein a plurality of windows may co-exist in the graphical user interface and the opaque window is created such that it would be displayed on top of other windows.

19. The apparatus of claim 16, wherein the off state is associated with a system's low-power state.

20. The apparatus of claim 16, wherein said determining comprises:
receiving from a user a request to turn off the display unit.

21. The apparatus of claim 16, wherein execution of the instructions further result in the following:
determining that the display unit is to be in an on state; and
arranging for the opaque window to be removed.

22. The apparatus of claim 16, wherein the display unit is associated with at least one of: (i) a desktop personal computer; (ii) a mobile system, (iii) a workstation, (iv) a server, (v) a set top box, and (vi) a game system.

23. The apparatus of claim 16, wherein at least one of said determining and said arranging is associated with at least one of: (i) a software application, (ii) a hardware device, (iii) an operating system, (iv) a driver, and (v) a basic input/output system.

24. A computer system, comprising:
a random access memory unit to store graphical information;
a processor to execute an operating system associated with graphical user interface windows, wherein an opaque window is created in response to a determination that a display unit is to be in an off state.

25. The computer system of claim 24, wherein the opaque window occupies substantially all of a graphical user interface area.

26. The computer system of claim 24, wherein a plurality of windows may co-exist in the graphical user interface and the opaque window is created such that it would be displayed on top of other windows.
